(19) United States
(12) Patent Application Publication
(10) Pub. No.: US 2002/0120557 A1
(43) Pub. Date: Aug. 29, 2002

(54) Automatic loan administration system

(76) Inventor: Yung-Sung Chien, Taipei (TW)

Correspondence Address: BACON & THOMAS, 625 Slaters Lane - 4th Floor, Alexandria, VA, 22314, US

(21) Appl. No.: 09/747,961

(22) Filed: Dec. 27, 2000

(51) Int. Cl. G06F 17/60

(52) U.S. Cl. 705/38

(57) ABSTRACT

An automatic financing administration system of this invention is provided. In the automatic financing administration system of this invention, the roles of provider and user of loans are integrated and all participants in a financing operation are made members of a group. The financing transactions in said financing group are conducted in a computerized network automatically. Limitations in number of member, amount per transaction and existing term of a financing group are selectively decided. An automatic financing administrative system is able to automatically control the financing transactions of an unlimited plurality of financing groups.

### FIELD OF INVENTION

The present invention relates to an automatic loan administration system, especially to an automatic loan administration device and method used in a communication network.

### BACKGROUND OF INVENTION

In the recent days, the network communication system has been widely established in every area of the world. Electronic financing networks or networked financing systems are under construction in every country. Among all the electronic financing networks or networked financing systems already available, two trends are observed.

The first trend is the digitization of payment tools. This means the provision of an automatic network communication system so that the money transactions between the banks and their customers may be done through the network system. In doing this, the credit investigation of a particular customer is conducted separately. A credit line for the customer is thus given. After the investigation, the customer is entitled to request a loan at any time during the valid term of his/her credit allowed, if the amount of the loan is within the allowable amount under said credit policy. Such request is passed to the bank through the network communication system. When a request of loan is approved, the bank will remit the loaned money to the customer through the network communication system. When the customer returns the loan, the channel of the return is also made through the network communication system. Due to the help of the network communication system, the calculation of all fees and amounts are clear and open. Many time consuming labors may thus be saved.

Although the network communication system is able to help a bank in its transactions with his customers, the whole procedure is just the same as when no network communication system is available. In the procedure, the credit investigation is conducted manually, wherein the network communication system provides almost no facility. From this point of view, the network communication system does not provide any additional function other than what the human being do. A more important question is that the bank is not aware who, in the unlimited number of users of the network communication system, is in need of the financing services that the bank provides, such that the bank may conduct the credit investigation in advance. As a result, it is difficult to realize the “electronic commerce” in the network communication system for the product of money, because all electronic commercial transactions can only take place between or among or with members of a electronic commerce group. In addition, the traditional financing transactions of banks only takes place between the bank and a particular customer. There is very few activities that require the help of the advanced network communication system. In other words, even if the network communication system is introduced into the banking operations, the whole procedure of the banking operations is not changed. The facilities that a network communication system can provide are not well utilized in the banking operation.

IN addition, under such a transaction model, the cost which the customers should burden is decided by the bank unilaterally. Fairness and flexibility in deciding the price of financing services is not achieved, even though the network communication system is applied.

The second trend in using the network communication system in the financing service is the match making service through the internet. In the internet, a request of loan may be spread to an unlimited number of receivers at a short time. In the same manner, an offer to lend money may also be transmitted to possible borrowers through the internet. Using this feature, it is possible to develop a matching service system in the internet. Potential lenders are matched with potential borrowers. When a transaction is succeeded, a commission is paid to the matchmaker.

Although such a matchmaking service is theoretically possible, a dilemma exists in such a system. Since the internet is widespread to an unlimited number of users, it is then impossible to conduct a credit investigation before a transaction is made. As a result, at the time when a transaction is almost closed, neither party of the transaction has the knowledge about who the other party is. Safety is thus a question in such a matchmaking system.

As described above, for almost all electronic commercial transactions in the internet, membership is always necessary. In other words, participants in all transaction need to be investigated and authenticated before they are allowed to participate in any of the activities. In order to achieve this purpose, it is possible to conduct credit investigations after a participant has become a member. However, if such a procedure is necessary, the above-mentioned features of the internet, i.e., the widespread of the internet and the unlimited number of potential participants through the internet, are thus lost. The financial transaction may only take place among limited number of members. On the other hand, if the number of members becomes great, such a group is not a membership group anymore.

It is thus necessary to provide an automatic financing administration system that, with the help of the network communication technology, is able to automatically conduct most financial activities of a financial transaction.

It is also necessary to provide an automatic financing administration system that is able to break through the limitation of transactions among members in the internet system and is able to expand its scope of transaction participants to all users of the internet.

It is also necessary to provide an automatic financing administration system wherein prices of financing or loan may be decided by the parties concerned.

### OBJECTIVES OF INVENTION

The objective of this invention is to provide an automatic financing administration system wherein most financing activities are conducted automatically.

Another objective of this invention is to provide an automatic financing administration system which is able to break through the limitation of transaction only among members in the internet and is able to expand the scope of transaction participants to almost all internet users but is able to maintain all transactions to be taken place only among members.

Another objective of this invention is to provide an automatic financing administration system wherein prices for financing or loan may be decided by the parties concerned.

### SUMMARY OF INVENTION

According to this invention, an automatic financing administration system is provided. In the automatic financing administration system of this invention, the roles of provider and user of loans are integrated and all participants in a financing operation are made members of a group. The financing transactions in said financing group are conducted in a computerized network automatically. Limitations in number of member, amount per transaction and existing term of a financing group are selectively decided. An automatic financing administrative system is able to automatically control the financing transactions of an unlimited plurality of financing groups.

The above and other objectives and advantages of this invention may be clearly understood from the detailed description by referring to the following drawing.

### BRIEF DESCRIPTION OF DRAWING

FIG. 1 illustrates the system diagram of the automatic financing administration system of this invention.

### DETAILED DESCRIPTION OF INVENTION

The following is a detailed description of the structure, functions and applications of the automatic financing administration system of this invention.

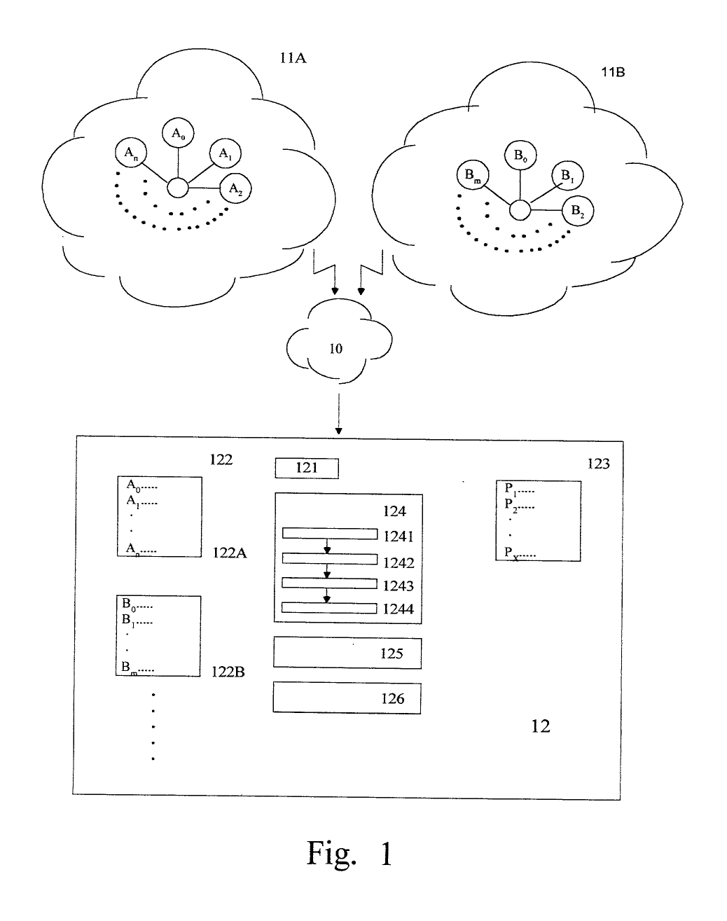

Description of the structure of the automatic financing administration system will be given first. FIG. 1 illustrates the system diagram of the automatic financing administration system of this invention. As shown in this figure, the automatic financing administration system of this invention may be installed in a communication network 10. In general cases the communication net work 10 may be the internet However, other public network or private network that is able to allow a plurality of members to participate in the financing activities administrated by the automatic financing administration system of this invention may be suited in this invention.

In the automatic financing administration system of this invention, financing groups 11A, 11B, . . . are provided. These financing groups 11A, 11B, . . . are organized manually. In FIG. 1, only two financing groups 11A and 11B are shown. Every financing group comprises of same or different number of members A0, A1, . . . , An (for group 11A) and B0, B1, . . . , Bn (for group 11B). All such members are users of the automatic financing administration system of this invention and participate in the financing activities provided by the automatic financing administration system of this invention by accessing to the communication network 10 through communication equipments, such as personal computers or network computers, at user sites.

It should be mentioned that, in the above-said communication network, a financing group is not always a physically existing hardware structure. In most applications, the organization of a financing group is to designate particular users of the automatic financing administration system of this invention as members of a financing group, whereby the financing activities pertaining to the financing group are limited to among members of the related group. In the embodiments of the automatic financing administration system of this invention, a member of a financing group may also be members of other financing groups at the same time.

In such a structure, the functions of the communication network include transmitting or exchanging financing transaction and other information, which is necessary in the administration of the related financing activities to or between or among members. In such an automatic financing administration system, number of financing groups as supported is not limited, so long as the quantity of data and information as processed and stored is within the limitations of the communication network and the limitations of the automatic financing administration system of this invention. As shown in FIG. 1, the automatic financing administration system 12 of this invention is also connected to the communication network 10, whereby the administration of the financing activities of all financing groups are administrated by the automatic financing administration system of this invention.

The structure of the automatic financing administration system 12 of this invention is shown in FIG. 1. As shown, the automatic financing administration system 12 of this invention comprises a communication interface 121 to conduct necessary communications through the communication network 10; a financing activity database 122 provided with financing group activity databases 122A, 122B, . . . for financing groups 11A, 11B, . . . ; a membership database 123 provided with personal information P1, P2, . . ., Px of members of the financing groups 11A, 11B, . . . and members not belonging to any financing groups; a financing group administration module 124 to control the activities of all financing groups 11A, 11B, . . . , a member administration module 125 to administrate financing and non-financing activities of members as recorded in the membership database 123; and a finance administration module 126 to administrate payment activities generated from the financing transaction activities of the financing groups 11A, 11B, . . .

Although it is not desired to limit the scope of this invention, in the automatic financing administration system of this invention, all financing activities are operated within respective financing groups. An automatic financing administration system capable of administrating a large quantity of financing groups is provided to administrate the financing activities of all financing groups, such that automatic administration of financing activities may be realized.

In order to describe the administrative operations of the automatic financing administration system of this invention, it is necessary to describe the financing operation of the financing groups first.

The financing operation applicable to this invention includes periodical financial transactions among members of respective financing groups. No need to say that other financial transactions with similar characters may also be suited in the automatic financing administration system of this invention. One major purpose of this invention is to provide the automatic matching and arbitrations of financing transactions among members of a financing group, other than matching and arbitrations among all users of a communication network. In most applications of this invention, the financial transaction is designed as periodical and fixed-amount transactions. Under such a design, financial transactions are operated periodically within a predetermined term and amounts of all transactions are fixed. Such a transaction mode is similar to the “Herhui” [symbol] system in the traditional Chinese society. The Herhui system is thus taken for reference in this invention and a brief description of the Herhui financial transaction system will be given in the followings.

In a Herhui system, only members of a financial group (a Herhui) is allowed to participate in the financial activities of the group. Upon organization of a Herhui, fonder of the financial group invites a plurality of members to join the financial group and issue a written Herhui agreement to all members. In the Herhui agreement, personal information such as names and addresses of members, number of members, unit amount of each financial transaction, maximum and minimum amount of loan interest, way of bid (interest inclusive or interest exclusive) and other information are described.

For a financing group of N+1 members, rules of financing activities are as follows:

In the initial transaction (bit No. 0), no bidding is necessary. Founder (member No. 0) of the Herhui is entitled to the total amount of loan money paid by all members (members M1-MN) and the amount of the loan money A0 is:

A0=U*N (1)

Wherein A0 represents the total amount of loan money for bit No. 0, U represents the unit amount of the financing transaction, N is number of members exclusive of founder. The financing group has N+1 members.

The financing activity of the Herhui is operated periodically. In most cases, the financing activities is operated monthly or weekly. The loan money in the financial transactions following the initial transaction will belong to who wins the bid. In the following transactions, only those members who have not won a bid (a “live member ”) in the proceeding financial transactions are allowed to compete in the bids. As a result, the amount of loan money (An) in the nth transaction is:

An=(U−In)×(N−n)+U×n, for interest inclusive transactions (2)

or

$$A n = U \times N + {\sum }_{i = 1}^{n - 1} I i , for interest exclusive transactions . \qquad ( 3 )$$

Wherein n represents ordinal number of the transaction in the Herhui with the initial transaction being the 0^{th} transaction, 0 <n ≦N, In represents the total amount of loan money in the nth transaction, In represents the amount of interest of the nth transaction, as offered by the winning member, and Ii represents the amount of interest of the ith transaction, as offered by the winning member of that transaction.

The total amount of loan money of a transaction and the money paid by each member are as follows:

1. The total loan money of the 0ₜₕ transaction is A0—Founder of the Herhui needs not to pay to other members but is entitled to the total loan money. All members shall pay to founder the amount of U.

2. In the first transaction and thereafter, the total loan money of the transaction is An. In an interest exclusive transaction wherein interest of a loan is added to the unit amount of transaction, equation (3) is applied:

I. The winning member of the transaction Mn who offers the highest amount of interest needs not to pay to other members but is entitled to the total amount of loan money of the transaction An.

II. Any member who has ever won a bid (a “dead member”, number of dead members being n and including members M0-Mn-1) shall pay to the winning member U+Ii wherein Ii represents the interest as offered by the dead member in the transaction as winning member (the ith transaction), 0<I<n; I0=0.

III. Other members (Mn+1−MN) shall pay to the winner member Mn unit amount U, respectively.

3. In an interest inclusive transaction wherein interest of a loan is included in the unit amount of transaction, equation (2) is applied:

I. The winning member of the transaction Mn who offers the highest amount of interest needs not to pay to other members but is entitled to the total amount of loan money of the transaction An.

II. Each dead member shall pay to the winning member the unit amount.

III. Other members shall pay to the winner member Mn the amount equal to U-In, respectively.

4. In one transaction, a non-winning member of a transaction shall pay to the winning member:

I. As a live member, the amount of the unit amount U in an interest exclusive transaction or the amount of the unit amount minus the winning amount of interest, U-In, in an interest inclusive transaction.

II. As dead member, the amount of the unit amount plus the amount of interest offered by the dead member in his/her winning transaction (U+Ii), in an interest exclusive transaction, or the amount of the unit amount U in an interest inclusive transaction.

III. As a winning member, no payment.

5. For a winning member of a transaction:

I. The winning member is entitled to the total amount of loan money An.

II. The amount he/she has paid in the Herhui is U*n in an interest exclusive transaction or is

$$U \times N - {\sum }_{i = 1}^{n - 1} I i$$

in an interest inclusive transaction.

III. In each of the following transactions, the now winning member shall pay to the respective winner the amount of U+In for an interest exclusive transaction or the unit amount U for an interest inclusive transaction.

In operating the financial transaction of a Herhui, a deadline prior to each transaction is set. All live members are invited to offer an amount of interest to participate in the competition. Any live member who wishes to make a loan may express his/her offer to founder of the Herhui. The offered amounts are kept confidential until the deadline. The live member who offers the highest amount of interest before the deadline is the winning member and is entitled to the total amount of that transaction. If no live member makes any offer, the winning member is decided according to a predetermined rule. In most cases, the winner is selected by a draw conducted by the founder. In some other cases, the winner is the member with the least or greatest ordinal number, or any order, in the Herhui agreement. In such a case, the amount of interest is the minimum amount of interest as provided in the Herhui agreement.

In such a Herhui financing system, founder of a Herhui is actuator of the financial group and is entitled to the total amount of the loan money in the initial (0^{th}) transaction. The founder is not responsible for paying any interest but is responsible to provide correct personal information of members, to provide necessary description, to conduct the bidding activities, to collect the payments of all members and to make payments to winning members. Under the Civil Code of Taiwan, founder of a Herhui is responsible to fulfill any unpaid amount of dead members to a winning member. See Article 709-7, Section II, latter part, of the Civil Code of Taiwan.

In such a system, a live member is provider of loans but is user after having become a winning member.

A member is entitled to a right to loan. Cost of the loan is the interests of money already paid before winning a bid, plus the interest offered when winning the bid. As a result, cost for a loan is decided according to competition.

The financial transaction is available only among members of a financing group. The transaction is operated periodically at a predetermined cycle. Providers of loans are able to predict demands of loans. For each transaction, a winner will be generated. In other words, all transactions will be successful.

In the automatic financing administration system of this invention, some operations are similar to that of the Herhui system.

According to the automatic financing administration system of this invention, the organization of the financing groups is conducted by the system in an active manner. Now refer to FIG. 1 again. As shown in this figure, in the member recruit module 1241 of the financing group administration module 124 generates combinations of organization conditions for possible financing groups and the combinations of conditions are published in the communication network 10. The conditions include unit amount of transactions, limitations of interests, number of transactions (members), period (frequency) of transactions etc. Any user of the communication network may apply to join any of the financing groups by sending an application through the communication network to the communication interface 121 of the automatic financing administration system 12. In order to attract members, numbers of members who are applying or allowed to join respective financing groups may be displayed. In addition, it is also possible to allow members or users to generate combination of conditions of a financing group.

Any user who wishes to apply for the membership of a financing group may obtain the screen display of the financing administration module 124 in his/her computer equipment through the communication network 10. In applying for a membership, the user shall provide his/her personal information as required and send the personal information to the financing administration module 124 in the format of, for example, electronic mail. The financing administration module 124 will than compare the membership number, personal information, password and other necessary information provided by the applicant with that stored in the financing administration module 124. After the comparison, if the applicant is identified as an authorized member, the result will be forwarded to the financing group organization module 1242 wherein the credit line and other factors (including used credit, history of financing activities etc.) of the applicant. Upon approval, the applicant will be given a financing group series number and a membership number in that financing group, such that the applicant is listed as a member of a particular financing group. In case the applicant is determined not qualified due to, for example, exhaustion of credit, the application will be rejected. In such a case, the application may also be forwarded to the credit investigation module 1243 of the financing administration module 124 to revise the credit information of the applicant to, for example, authorize a higher credit line.

In the preceding step, if the applicant is found to be not an authorized member, the application will be forwarded to the credit investigation module 1243 and a request for credit investigation will be generated to a handling department. The handling department will then conduct a credit investigation manually. The credit investigation will include confirmation of credit line, change of credit line etc. Results of credit investigation will be input to the credit investigation module 1243 within a predetermined period. When no input is found available within the predetermined period, the credit investigation module 1243 will generate an alert to the handling department to accelerate the procedure. If no response is input within a further predetermined period thereafter, the credit investigation module 1243 will generate an instruction to the financing administration module 124 to reject the application.

When the credit investigation module 1243 receives an order to confirm or to revise the credit line of the applicant, the message is forwarded to the member recruit module 1241 or the financing group organization module 1242.

If no satisfactory number of members is allowed to join a particular financing group within a predetermined period, an alert will be generated. As a result, the administrator of the automatic financing administration system and all members of the financing group will be noticed to take necessary actions. If no adjustment is made within a further predetermined period thereafter, all members of the financing group will be rejected.

The procedure of the credit investigation may be in accordance with the professional procedure in the practice of financial institutes. When the credit investigation is conducted offline, such procedure may be omitted from the automatic financing administration system of this invention. In such a case, a column showing the confirmed credit line of each member will be provided in the membership database 123 of the system 12, such that the credit line information of an applicant may be obtained and authorization may be generated.

After the credit investigation procedure, the personal information of the applicant will be stored in the membership database 123 by the membership administration module 125. After this step the applicant will be deemed an authorized member. In the membership database 123, stored is necessary and useful information of members, such as personal information, credit line, guarantees etc. When an authorized member is allowed to join a particular financing group, his /her personal information will also be stored in the financing group database 122 by the financing administration module 124. Data stored in the financing group database 122 may be linked to or shared with data stored in the membership database 123. Data stored in the financing group database 122 further include series number of financing group, membership number in the financing group, membership number as authorized, number of winning financing activities, detailed records of financing transactions participated and other dynamic information. Data store in the financing database 122 may be updated from time to time.

When a particular financing group is organized successfully, the information is forwarded to the financing transaction module 1244. In this step, the financing transaction module 1244 will generate an invitation in an electronic format to invite all members of that financing group to input an offer of interest. In some embodiments of this invention, the invitation is contained in an electronic mail and the electronic mail includes a response means (not shown), which generates a confirmation of receipt of the invitation when the invitation is received by a member. Such a response means may also generate a message to include the member's offer and reconfirmation thereof to the financing transaction module 1244. In addition, when the invitation is not duly received, the invitation will be resent automatically, or an alert will be generated such that necessary actions may be taken. When no offer is received from a member within a predetermined period, the member will be determined declining to offer. Under such situation, a request of confirmation may be generated and delivered to the member to confirm such fact.

Upon the expiration of the offering period, the financing transaction module 1244 compares the offers it received and selects the member with the highest offer to be the winning member of the financing transaction. If more than one member offers the highest amount, a proper selection operation, such as random selection, is conducted. If no member makes any offer, same selection operation is conducted. Winner member of the financing transaction is entitled to the total amount of loan money of that transaction. After such an operation, the result will be published to all members of the financing group concerned. Members of a financing group may also check the result of a competition or the history of the financing group through the communication network.

Before the deadline of a competition, the system allows a member to change his/her offer in the related financing transaction. In addition, information regarding following transactions is also accessible through the communication network. In an embodiment of this invention, a prediction module (not shown) is provided such that members may predict possible winning amount of interest in a following transaction. Such information is useful for members to decide an offer.

When the result of a competition is revealed, the information is forwarded to the finance administration module 126. Here, amounts that a non-winning member should pay will be calculated according to the applicable equations. Delay penalties will also be added into the amount due. The result of calculation will be noticed to all members respectively, through the communication network 10. In embodiment of this invention, a prediction function is provided, such that, when a member is member to more than one financing group, amounts due within a designated period of time may be calculated and shown. As a result, the member may decide to join other financing groups or to bit in a financing group wherein he/she is a live member, within the residue credit line of the member. When international financial transactions are available, currency exchange rates are dynamically taken for consideration in the finance administration module 126.

Payments of members may be made in an electronic format. Other methods of payment including cash payments are also applicable. At a predetermined time point the total amount of loan money An is remitted to the winning member. In most applications, the remittance is made in an electronic format. If any non-winning member fails to make proper payment, within a predetermined time period, the result will be sensed and forwarded to the finance administration module 126 to actuate collection procedures.

In the collection procedure, an electronic mail asking the respective member to make payment will first be generated and forwarded to the member through the communication network 10. In some circumstances, the finance administration module 126 may actuate a detain or deduction order to the deposit cash or electronic cash or the member, or to the rights of bidding of the member in a financing group where he/she is a live member, or to the rights of collection of the member in a financing group where he/she is a wing member. In some other circumstances, the rights to participate in the financial activities in the automatic financing administration system will be stopped until all due amounts are properly paid up. All such collection procedures may be executed automatically in the finance administration module of this invention.

After the loan money is remitted to the winning member, the message is forwarded to the financing group administration module 124 to accept offers for the next competition.

In the automatic financing administration system of this invention, there is no “founders” of financing groups. The financing groups are organized by the system according to predetermined conditions automatically. After a financing group is organized, electronic financing transactions are conducted automatically.

### EFFECTS OF INVENTION

In the automatic financing administration system of this invention, participants of financial transactions are divided into groups and financial transactions are conducted periodically. As a result, inherited difficulties of financial transactions in the communication network may be overcome. When a substantial amount of members and financing groups are participating in the financing transaction, the idea of an electronic financing system in the communication network, such as the internet, may be realized. In such an electronic financing system, only authorized members are allowed to participate in a financial transaction. With the help of the credit investigation module, number of members is not limited. Risks in the electronic financing system may be greatly reduced.

This invention provides a novel financial transaction mode. In the invented system, providers of loans are able to predict when a loan is needed. Users of loans may also predict when a loan is available. Under the invented system, cost of a loan is decided through competition, rather than decided by loan providers as in the traditional banking system. A dynamic financial system may be realized.

With the automatic financing administration system of this invention, both providers and users of loans are well protected. Safety of financial transactions in a virtual communication network may be secured.

As the present invention has been shown and described with reference to preferred embodiments thereof, those skilled in the art will recognize that the above and other changes may be made therein without departing from the spirit and scope of the invention.

What is claimed is:

1. An automatic financing administration system, comprising:
a communication interface allowing communication between said automatic financing administration system and a network communication system;
a membership database storing personal information of members who are allowed to participate in financing transactions under the administration of said automatic financing administration system; which personal information comprising credit information including credit lines of members and payment history of members;
a membership administration module allowing adding, deleting and revision of said personal information stored in said membership database;
a financing group database comprising a plurality of historical files containing personal information of members allocated to respective financing groups and history of financing activities of said members;
a financing group administration module to add, delete and revise said historical files in said financing group database, to automatically decide respective winners of substantially fixed-amounted financing activities among said members allocated to respective financing groups periodically, and to automatically calculate amounts of money in said respective financing activities; and
a finance administration module to conduct collection and payments of financing activities wherein winners are decided by said financing group administration module;
characterized in that decision of winner of a financing activity by said financing group administration module comprises the following steps:
prior to a deadline, receiving offers of bids of loan interests from members designated to a financing group which members has not won in a financing activity in said financing group in a previous time;
at said deadline, comparing amounts of said offers of bids and deciding member offering the highest amount as winner of said financing activity; and
if no offer is received, selecting a member from members who has not won a financing activity in said financing group in a previous time as winner of said financing activity randomly or under a predetermined order.

2. The automatic financing administration system according to claim 1 wherein said amounts of money in a financing activity comprises amounts of money to be collected from members in a financing activity and calculation of said amounts comprises the following steps:
amount of money to be collected from a member who has won a bid in a previous time is a unit amount plus said amount of loan interest offered by the winning member in said financing activity;
amount of money to be collected from a member who has not won a bid in a previous time and in said financing activity is said unit amount; and
amount of money to be collected from winning member of said financing activity is 0; and
wherein said unit amount is a predetermined amount.

3. The automatic financing administration system according to claim 1 wherein said amounts of money in a financing activity comprises amounts of money to be collected from members in a financing activity and calculation of said amounts comprises the following steps:
amount of money to be collected from a member who has won a bid in a previous time is a unit amount;
amount of money to be collected from a member who has not won a bid in a previous time and in said financing activity is said unit amount minus said amount of loan interest offered by the winning member in said financing activity; and
amount of money to be collected from winning member of said financing activity is 0; and
wherein said unit amount is a predetermined amount.

4. The automatic financing administration system according to anyone of claims 1, 2 and 3, wherein said financing group administration module further comprises:
a financing group recruiting module to generate transaction conditions of various financing groups, allowing members whose personal information is stored in said membership database to input requests to be designated to a particular financing group;
a credit investigation module to, upon said request, automatically decide whether a member is allowed to be designated to a said particular financing group according to said personal information stored in said membership database; and
a financing organization module to generate a financing group data file in said financing group database when number of members allowed to be designated to said particular financing group is equal to or greater than a predetermined number.

5. A method for automatically administrating financing activities for an automatic financing administration comprising:
a communication interface allowing communication between said automatic financing administration system and a network communication system;
a membership database storing personal information of members who are allowed to participate in financing transactions under the administration of said automatic financing administration system; which personal information comprising credit information including credit lines of members and payment history of members;
a membership administration module allowing adding, deleting and revision of said personal information stored in said membership database;
a financing group database comprising a plurality of historical files containing personal information of members allocated to respective financing groups and history of financing activities of said members;
a financing group administration module to add, delete and revise said historical files in said financing group database, to automatically decide respective winners of substantially fixed-amounted financing activities among said members allocated to respective financing groups periodically, and to automatically calculate amounts of money in said respective financing activities; and
a finance administration module to conduct collection and payments of financing activities wherein winners are decided by said financing group administration module;
said method comprising the following steps:
prior to a deadline, receiving offers of bids of loan interests from members designated to a financing group which members has not won in a financing activity in said financing group in a previous time;
at said deadline, comparing amounts of said offers of bids and deciding member offering the highest amount as winner of said financing activity; and
if no offer is received, selecting a member from members who has not won a financing activity in said financing group in a previous time as winner of said financing activity randomly or under a predetermined order.

6. The method according to claim 5 wherein said amounts of money in a financing activity comprises amounts of money to be collected from members in a financing activity and calculation of said amounts comprises the following steps:
amount of money to be collected from a member who has won a bid in a previous time is a unit amount plus said amount of loan interest offered by the winning member in said financing activity;
amount of money to be collected from a member who has not won a bid in a previous time and in said financing activity is said unit amount; and
amount of money to be collected from winning member of said financing activity is 0; and
wherein said unit amount is a predetermined amount.

7. The method according to claim 5 wherein said amounts of money in a financing activity comprises amounts of money to be collected from members in a financing activity and calculation of said amounts comprises the following steps:
amount of money to be collected from a member who has won a bid in a previous time is a unit amount;
amount of money to be collected from a member who has not won a bid in a previous time and in said financing activity is said unit amount minus said amount of loan interest offered by the winning member in said financing activity ; and
amount of money to be collected from winning member of said financing activity is 0; and
wherein said unit amount is a predetermined amount.
